(19) United States
(12) Patent Application Publication
(10) Pub. No.: US 2021/0397156 A1
(43) Pub. Date: Dec. 23, 2021

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventors: Yuta NAKAMORI, Tokyo (JP); Kengo TOKUCHI, Kanagawa (JP)

(73) Assignee: FUJIFILM Business Innovation Corp., Tokyo (JP)

(21) Appl. No.: 16/953,289

(22) Filed: Nov. 19, 2020

(30) Foreign Application Priority Data
Jun. 19, 2020 (JP) 2020-106211

(51) Int. Cl. G05B 19/4099; G06F 30/00; G06Q 30/06

(52) U.S. Cl. CPC G05B 19/4099; G06F 2113/10; G06Q 30/0635; G06F 30/00

(57) ABSTRACT

An information processing apparatus includes a processor configured to receive input of information for identifying a target object for manufacturing, identify a component of the target object, and create management information to manage classification of the component of the target object as a first kind of component or a second kind of component, the first kind of component being a component produced by a three-dimensional printer, the second kind of component being a component procured without using the three-dimensional printer.

### CROSS-REFERENCE TO RELATED APPLICATIONS

This application is based on and claims priority under 35 USC 119 from Japanese Patent Application No. 2020-106211 filed Jun. 19, 2020.

### BACKGROUND

### (i) Technical Field

The present disclosure relates to an information processing apparatus and a non-transitory computer readable medium.

### (ii) Related Art

Japanese Unexamined Patent Application Publication No. 2001-261120 describes a disclosure aiming to provide a method and system that are used for logistics management and that enable a real-time grasp of the information regarding locations of dollies and the types and the numbers of loads carried by each dolly. The dollies are used in all stages of a logistics process and include roll-box pallets. The method and system not only enable efficient logistics management but also can increase the reuse rates of the dollies.

Japanese Unexamined Patent Application Publication No. 2015-138471 describes a disclosure aiming to provide a three-dimensional-printer assistance program, a medium to record the three-dimensional-printer assistance program, and a three-dimensional-printer assistance apparatus to store the three-dimensional-printer assistance program. The three-dimensional-printer assistance program performs a realistic simulation of the surface roughness of a three-dimensional object and enables the three-dimensional object to be examined without actually forming the object by using a three-dimensional printer.

Japanese Unexamined Patent Application Publication No. 2016-85501 describes a disclosure aiming to provide a measurement-and-control system assistance apparatus that enables maintenance operation personnel including service operators to grasp physical distances and positional relationships quickly and precisely in a place and its vicinity, where an anomaly has occurred in a plant.

Japanese Patent No. 5891586 describes a disclosure aiming to provide a computer-aided design (CAD) data creation apparatus and a program and storage medium for creating CAD data. The CAD data creation apparatus and the program and storage medium are suitable for forming a three-dimensional object by using a three-dimensional printer. The disclosure aims in particular to create three-dimensional CAD data of a structure in each stage of a construction process. The disclosure also aims to provide a CAD data creation apparatus for creating three-dimensional CAD data to form a target three-dimensional object as a single integrated body. The three-dimensional CAD data is created so that the target three-dimensional object can be disassembled.

### SUMMARY

When objects are manufactured by using a three-dimensional printer, the manufacture completes only by using the three-dimensional printer in some cases. In other cases, the manufacture involves components produced by using other methods. However, for manufacture based on a combination of acquisition and production of materials, there is no technology known in the art to manage the information for manufacturing a target object.

Aspects of non-limiting embodiments of the present disclosure relate to providing an information processing apparatus and a non-transitory computer readable medium that can manage the information for manufacturing a target object by using a three-dimensional printer.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to receive input of information for identifying a target object for manufacturing, identify a component of the target object, and create management information to manage classification of the component of the target object as a first kind of component or a second kind of component, the first kind of component being a component produced by a three-dimensional printer, the second kind of component being a component procured without using the three-dimensional printer.

### BRIEF DESCRIPTION OF THE DRAWINGS

An exemplary embodiment of the present disclosure will be described in detail based on the following figures, wherein:

FIG. 1 is an illustration for describing an information processing apparatus according to the present exemplary embodiment;

FIG. 2 is a block diagram depicting a hardware configuration of the information processing apparatus;

FIG. 3 is a block diagram depicting an example of a functional configuration of the information processing apparatus;

FIG. 4 is an illustration depicting an example of management information;

FIG. 5 is a flowchart depicting a flow of a process that is performed by the information processing apparatus for managing components; and

FIG. 6 is an illustration depicting an example of structured information.

### DETAILED DESCRIPTION

Hereinafter, an exemplary embodiment according to the present disclosure will be described with reference to the drawings. In the figures, the same or equivalent elements and parts are denoted by the same reference signs. The dimensions and proportions in the figures are emphasized for the sake of description and are not necessarily drawn to scale.

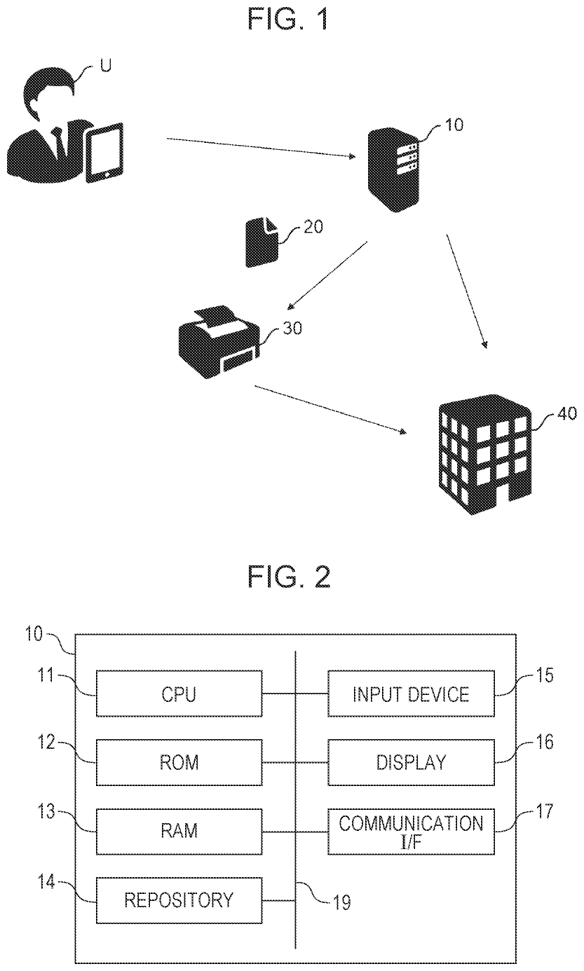

FIG. 1 is an illustration for describing an information processing apparatus according to the present exemplary embodiment. An information processing apparatus 10 according to the present exemplary embodiment acquires information regarding a target product 40 from a user U and identifies information regarding components of the target product 40. Then, the information processing apparatus 10 determines whether each identified component can be output from a three-dimensional (3D) printer 30 or is procured without using the 3D printer 30. The target product 40 is not limited to a specific object as long as the target product 40 includes one or more components that can be output from the 3D printer 30.

The information processing apparatus 10 creates 3D data 20 for a component that can be output from the 3D printer 30. The 3D printer 30 outputs the component by using the 3D data 20. For example, the 3D data 20 may be data in the Extensible Markup Language (XML) format, in which a voxel is used as a unit element and the size and material of each element are specified to represent a three-dimensional body. Examples of such data include data in conformity with the “FAbricatable Voxel” (FAV), which is a data format for 3D printing. The FAV format is a data format for a 3D printer, and the data in the FAV format can retain complicated three-dimensional information including the internal structure, colors, materials, and connection strength of a three-dimensional object. Obviously, the data format that can be used for 3D printing in the present disclosure is not limited to the FAV format. For example, a data format in which data representing a three-dimensional form is stored in a text format or in a binary format and a data format in which data representing a three-dimensional form is described in an XML format other than the FAV format are also usable in the present disclosure. Examples of the former include a data format such as the Standard Triangulated Language (STL) format, and examples of the latter include data formats such as the Additive Manufacturing File Format (AMF) and the 3D Manufacturing Format (3MF).

For a component that cannot be output from the 3D printer 30, the information processing apparatus 10 creates information to procure the component. The information to procure the component may be, for example, information to place a purchase order to a manufacturer of the component. Alternatively, if the component can be output from a 3D printer that differs from the 3D printer 30, the information to procure the component may be 3D data to output the component from the 3D printer that differs from the 3D printer 30.

The information processing apparatus 10 may refer to information recorded on a server 50 to determine whether a component can be output from the 3D printer 30 or is procured without using the 3D printer 30. The server 50 retains, for example, information indicating whether a component can be output from the 3D printer 30, information regarding the procurement of a component, information regarding the cost associated with output or procurement of a component, and other information.

In accordance with the 3D data 20, the 3D printer 30 outputs one or more components that constitute the target product 40. The target product 40 is formed by the one or more components that are output from the 3D printer 30 and one or more components that are procured differently.

FIG. 2 is a block diagram depicting a hardware configuration of the information processing apparatus 10.

As depicted in FIG. 2, the information processing apparatus 10 includes a central processing unit (CPU) 11, a read-only memory (ROM) 12, a random-access memory (RAM) 13, a repository 14, an input device 15, a display 16, and a communication interface (I/F) 17. These units are communicatively connected to each other by using a bus 19.

The CPU 11, which is a central computing processing unit, executes various programs and controls each unit. Specifically, the CPU 11 loads programs from the ROM 12 or from the repository 14 and uses the RAM 13 as a working space to execute the programs. The CPU 11 controls each unit described above and performs various kinds of computing processing in accordance with the programs recorded on the ROM 12 or on the repository 14. In the present exemplary embodiment, an information processing program to determine whether a component can be output from the 3D printer 30 is stored in the ROM 12 or in the repository 14.

The ROM 12 stores various programs and various kinds of data. The RAM 13 as the working space temporarily retains programs or data. A storage device such as a hard disk drive (HDD), a solid state drive (SSD), or a flash memory constitutes the repository 14, which stores various programs including the operating system and various kinds of data.

The input device 15 includes a pointing device, such as a mouse, and a keyboard and is used for receiving various kinds of input.

The display 16 is, for example, a liquid crystal display and displays various kinds of information. A touch panel system may be adopted for the display 16 and may also function as the input device 15.

The communication interface 17 is an interface for communicating with other apparatuses, such as the 3D printer 30 and the server 50, and such a standard as the Ethernet (registered trademark), fiber distributed data interface (FDDI), or Wi-Fi (registered trademark) is used.

While executing the information processing program above, the information processing apparatus 10 uses the hardware resource described above and realizes various functions. A functional configuration realized by the information processing apparatus 10 will be described.

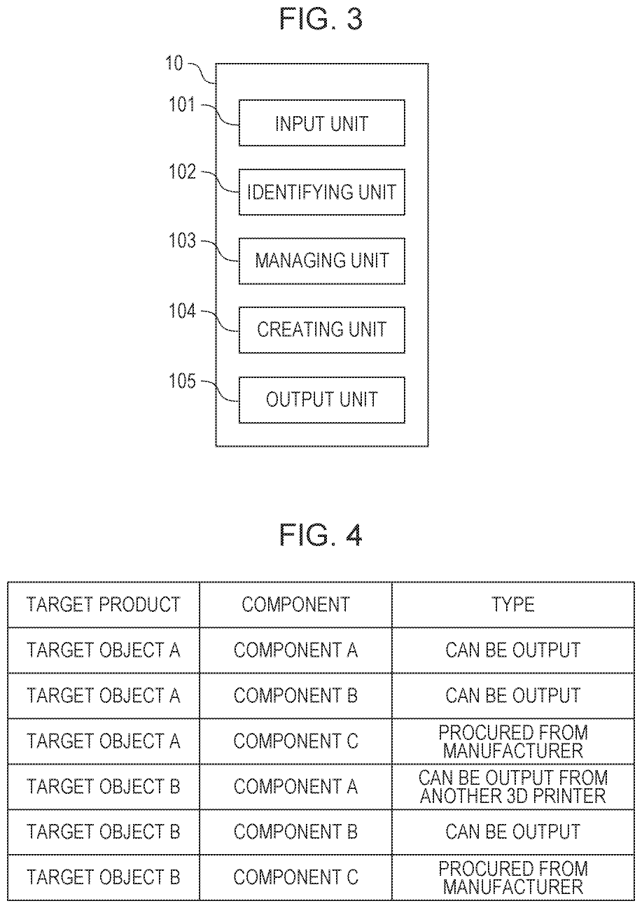

FIG. 3 is a block diagram depicting an example of the functional configuration of the information processing apparatus 10.

As depicted in FIG. 3, the information processing apparatus 10 includes an input unit 101, an identifying unit 102, a managing unit 103, a creating unit 104, and an output unit 105 as the functional configuration. Each functional section is realized by the CPU 11, which loads and executes the information processing program stored in the ROM 12 or in the repository 14.

The input unit 101 acquires information regarding the target product 40 from the user U. The information regarding the target product 40 may be, for example, design information regarding the target product 40, and the design information includes plans and materials. The information regarding the target product 40 may also be, for example, an image of the target product 40, which is captured by a camera. The information regarding the target product 40 may also be, for example, information acquired from the server 50 or the like by reading a two-dimensional code attached to the target product 40. The design information regarding the target product 40 may be, for example, two-dimensional or three-dimensional CAD data. The design information regarding the target product 40 may also be, for example, data obtained by scanning plans drawn on a sheet of paper.

The identifying unit 102 identifies one or more components of the target product 40 by using information that is acquired via the input unit 101 and that concerns the target product 40. For example, if design information regarding the target product 40 is acquired, the identifying unit 102 identifies each component by using the size, material, and other information that are designated in the design information. If two-dimensional or three-dimensional CAD data is acquired via the input unit 101, the identifying unit 102 identifies each component of the target product 40 by using the CAD data. If scanned data obtained by scanning plans drawn on a sheet of paper is acquired via the input unit 101, the identifying unit 102 identifies each component of the target product 40 by using the scanned data. Further, for example, if a captured image of the target product 40 is acquired, the identifying unit 102 identifies each component by analyzing the captured image. The identifying unit 102 may use, for example, a learned model obtained by machine learning performed based on predetermined training data and may identify each component of the target product 40 by using an image of the target product 40 captured by a camera. The learned model may be stored, for example, in the server 50.

Then, the identifying unit 102 determines whether each identified component of the target product 40 can be output from the 3D printer 30 or is procured without using the 3D printer 30. In the following description, a component that can be output from the 3D printer 30 is also referred to as a “component of the first kind”, and a component that is procured without using the 3D printer 30 is also referred to as a “component of the second kind”. The identifying unit 102 refers to information regarding performance capabilities of the 3D printer 30 to determine whether a component is of the first kind or of the second kind. The information regarding performance capabilities of the 3D printer 30 may include, for example, the size of a component that can be output, usable materials, and unit time required to output a component.

In this example, it is assumed that the identifying unit 102 has determined that the target product 40 is formed by three components, which are a component A, a component B, and a component C. The identifying unit 102 determines whether each of the three components, which have been identified, is of the first kind or of the second kind.

The identifying unit 102 may determine whether a component is of the first kind or of the second kind in accordance with structured information that is structured with respect to components. An example of the structured information will be described below. The identifying unit 102 may use information retained by the information processing apparatus 10 or information stored in the server 50 to determine whether a component is of the first kind or of the second kind. The identifying unit 102 may determine whether a component is of the first kind or of the second kind, for example, by using a learned model obtained by machine learning.

In some cases, it cannot accurately be determined whether a component identified by the identifying unit 102 is of the first kind or of the second kind by using information stored in the server 50. In such cases, the identifying unit 102 may determine whether the component is of the first kind or of the second kind by using information regarding a component similar in shape to the identified component.

To determine whether a component is of the first kind or of the second kind, the identifying unit 102 may take into account the cost involved to output the component from the 3D printer 30. For example, if the cost involved to output a component from the 3D printer 30 is less than a predetermined threshold, the identifying unit 102 may determine that the component is of the first kind.

In some cases, for example, although the 3D printer 30 is not able to output a component at some point but is able to output the same component at another point after the performance capabilities of the 3D printer 30 have improved. In other cases, for example, although a large amount of cost is involved to output a component from the 3D printer 30 at some point, the 3D printer 30 is able to output the same component at a lower cost at another point after the material price has decreased. In other cases, for example, although a component is produced as a general-purpose product at some point, the component is unavailable since the production has been terminated. In other circumstances, a component to be adopted changes in accordance with a period of the year, such as a rainy season when the air is humid or wintertime when the air is dry. Similarly, in some cases, a component to be adopted changes in accordance with a daily weather condition. If the time at which the 3D printer 30 is to output a component is known in advance, a way to deal with the component may be specified in accordance with information regarding environment in the future when the component is output. Examples of the information regarding environment include information regarding a weather forecast. Thus, considering such cases, the identifying unit 102 may determine whether a component of the target product 40 is of the first kind or of the second kind in accordance with the time at which the component is identified. In such cases, the identifying unit 102 may determine whether the component is of the first kind or of the second kind by referring to the latest information that concerns components and that is stored in the server 50. The identifying unit 102 may also determine whether the component is of the first kind or of the second kind in accordance with the version of the information that is acquired via the input unit 101 and that concerns the target product 40.

In some cases, for example, although the 3D printer 30 located at one place is not able to output a component because of a property of a material, the 3D printer 30 located at another place is able to output the component despite such a property of the material. Thus, considering such cases, the identifying unit 102 may determine whether a component of the target product 40 is of the first kind or of the second kind in accordance with the place where the component of the target product 40 is identified.

The identifying unit 102 may take into account the quality of a target object into which components are assembled and may determine whether a component is of the first kind or of the second kind. For example, if the production cost of a target object is set to be emphasized, the identifying unit 102 may prioritize outputting a component from the 3D printer 30, and if the quality of a target object is set to be emphasized, the identifying unit 102 may prioritize procuring a component without using the 3D printer 30. The identifying unit 102 may allow a user to input a setting to emphasize the quality of a target object, for example, by using a graphical user interface (GUI).

The managing unit 103 creates management information to manage whether each component identified by the identifying unit 102 is of the first kind or of the second kind. In the above example, the managing unit 103 creates management information indicating that the components A and B are of the first kind and the component C is of the second kind. The managing unit 103 may transmit the created management information to the server 50. Concentrating management information in the server 50 increases the accuracy of a determination process performed by the identifying unit 102. Specifically, the identifying unit 102 may use other management information stored in the server 50 to determine whether a component is of the first kind or of the second kind.

FIG. 4 is an illustration depicting an example of management information created by the managing unit 103. For each component identified for an individual target product, whether the component can be output from the 3D printer 30 or is procured differently is managed by using the management information depicted in FIG. 4. In FIG. 4, although the management information is represented in the form of a database, the format of management information is not limited to this example, and management information may be described, for example, in the XML format. Describing management information in the XML format enables the information processing apparatus 10 to manage the data format for a component of the second kind in a manner similar to the manner for the data format for 3D printing.

The information processing apparatus 10 according to the present exemplary embodiment creates management information to manage whether each component is of the first kind or of the second kind and thus can manage information regarding what feature each component has.

When determining whether a component is of the first kind or of the second kind by referring to management information stored in the server 50, the identifying unit 102 may use the magnitude of the number of times that a piece of management information has been referred to. For example, if a larger number of users than a predetermined threshold refer to a piece of information indicating that a component is of the first kind, the identifying unit 102 may determine that the component is of the first kind.

The creating unit 104 creates data based on the management information created by the managing unit 103. If a component identified by the identifying unit 102 is of the first kind, the creating unit 104 creates the 3D data 20 to output the component from the 3D printer 30. The format of the 3D data 20 is not particularly limited, and as described above, the 3D data 20 may be provided in the XML format, in which a voxel is used as a unit element, and the size and material of each element are specified to represent a three-dimensional body. Examples of such data include data in conformity with the FAV format, which is a data format for 3D printing.

Further, if a component identified by the identifying unit 102 is of the second kind, the creating unit 104 creates data to procure the component without using the 3D printer 30. The creating unit 104 creates, for example, purchase order information to place a purchase order for the component to a manufacturer, and the purchase order information is created as the data to procure the component without using the 3D printer 30. In addition, if the component can be output from a 3D printer other than the 3D printer 30, the creating unit 104 creates 3D data to output the component from the 3D printer other than the 3D printer 30, and the 3D data is created as the data to procure the component without using the 3D printer 30. The format of the 3D data to output the component from the 3D printer other than the 3D printer 30 is not particularly limited either in such a case. As described above, the 3D data may be provided in the XML format, in which a voxel is used as a unit element, and the size and material of each element are specified to represent a three-dimensional body. Examples of such data include data in conformity with the FAV format, which is a data format for 3D printing.

The output unit 105 outputs data created by the creating unit 104. If the data created by the creating unit 104 is the 3D data 20 to output a component from the 3D printer 30, the output unit 105 outputs the 3D data 20 to the 3D printer 30. If the data created by the creating unit 104 is purchase order information to place a purchase order for a component to a manufacturer, the output unit 105 outputs the created purchase order information to a predetermined purchase order system. Further, if the data created by the creating unit 104 is 3D data to output a component from a 3D printer other than the 3D printer 30, the output unit 105 outputs the 3D data to the 3D printer other than the 3D printer 30.

Since the information processing apparatus 10 according to the present exemplary embodiment has the configuration described above, the information processing apparatus 10 can manage information to manufacture a target product by using a 3D printer and can output information to manufacture a target product.

Next, an operation of the information processing apparatus 10 will be described.

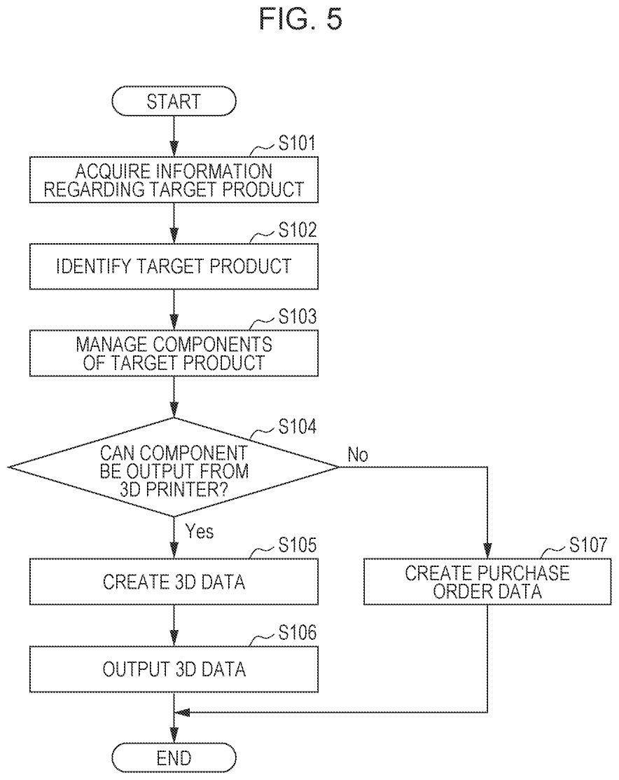

FIG. 5 is a flowchart depicting a flow of a process that is performed by the information processing apparatus 10 for managing components. The CPU 11 reads the information processing program stored in the ROM 12 or in the repository 14 and loads the information processing program onto the RAM 13 to execute the program, and then the process for managing components is performed.

First, the CPU 11 acquires information regarding the target product 40 from the user U (step S101). The information regarding the target product 40 may be, for example, design information regarding the target product 40, an image of the target product 40, which is captured by a camera, or information acquired from the server 50 or the like by reading a two-dimensional code attached to the target product 40. The design information regarding the target product 40 may be, for example, two-dimensional or three-dimensional CAD data.

Following step S101, the CPU 11 identifies components of the target product 40 by using the acquired information regarding the target product 40 (step S102). For example, if design information regarding the target product 40 is acquired, the CPU 11 identifies components by using the size, material, and other information that are specified by the design information. Further, for example, if a captured image of the target product 40 is acquired, the CPU 11 analyzes the captured image and identifies components. The CPU 11 may use, for example, a learned model obtained by machine learning and may identify components of the target product 40 by using an image of the target product 40 captured by a camera. The learned model may be stored, for example, in the server 50.

Following step S102, the CPU 11 manages identified components of the target product 40 (step S103). Specifically, the CPU 11 creates management information to manage whether each identified component is of the first kind or of the second kind. The format of the management information is not limited to a specific one. The CPU 11 creates the management information and thus manages the identified components of the target product 40. The CPU 11 may store the created management information in the repository 14 or may transmit the created management information to the server 50.

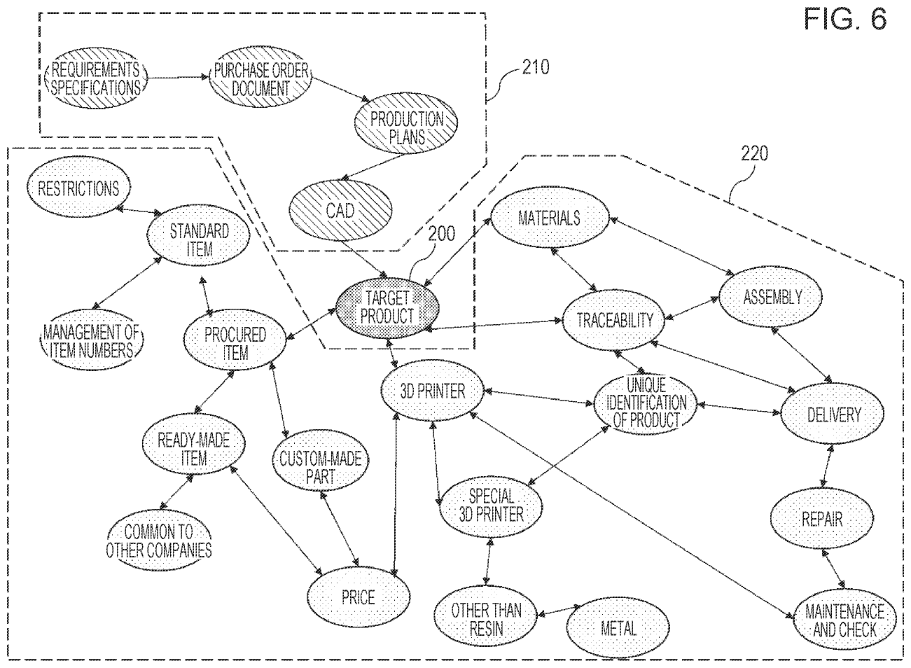

FIG. 6 is an illustration depicting an example of structured information, which is structured around a target product. A symbol 200 represents the target product, which is the center of the structured information. A symbol 210 represents information to be input into the information processing apparatus 10 to identify the target product. A symbol 220 represents a collection of pieces of information that is obtained by breaking down information starting from the target product and arranging the pieces of information in a structured manner. In the structured information depicted in FIG. 6, each arrow direction represents a parent-child relationship of two pieces of information.

For example, CAD data is necessary to manufacture the target product, and original production plans are necessary to create the CAD data. Some components of the target product can be produced by using a 3D printer, and some components need to be procured from outside. Further, if traceability of the target product or a component needs to be ensured, various kinds of information regarding traceability are necessary.

The CPU 11 may create management information to manage whether each identified component is of the first kind or of the second kind by referring to such structured information as is depicted in FIG. 6. Each time the CPU 11 creates management information, the CPU 11 may update the structured information.

Following step S103, for each identified component of the target product 40, the CPU 11 determines whether the identified component is of the first kind, that is, a component that can be output from the 3D printer 30 (step S104).

If an identified component of the target product 40 is of the first kind (Yes in step S104), the CPU 11 creates the 3D data 20 to output the identified component from the 3D printer 30 (step S105). The format of the 3D data 20 is not particularly limited, and as described above, the 3D data 20 may be provided in the XML format, in which a voxel is used as a unit element, and the size and material of each element are specified to represent a three-dimensional body. Examples of such data include data in conformity with the FAV format, which is a data format for 3D printing.

Following step S105, the CPU 11 outputs the created 3D data 20 to the 3D printer 30 (step S106).

In contrast, if an identified component of the target product 40 is not of the first kind (No in step S104), that is, if the identified component is of the second kind and is procured without using the 3D printer 30, the CPU 11 creates data to procure the identified component without using the 3D printer 30 (step S107). If an identified component is of the second kind, the CPU 11 creates, for example, purchase order information to place a purchase order for the component to a manufacturer, and the purchase order information is created as the data to procure the component without using the 3D printer 30. In addition, if a component can be output from a 3D printer other than the 3D printer 30, the CPU 11 creates 3D data to output the component from the 3D printer other than the 3D printer 30, and the 3D data is created as the data to procure the component without using the 3D printer 30.

Since the information processing apparatus 10 according to the present exemplary embodiment performs the operation described above, the information processing apparatus 10 can manage information to manufacture a target product by using a 3D printer and can output information to manufacture a target product.

The information processing apparatus 10 according to the present exemplary embodiment can be applied to unique identification of the target product 40 by creating management information. Specifically, the information processing apparatus 10 creates management information to manage components of the target product 40 and thus can ensure that the same target product 40 is manufactured by using the same management information.

In the exemplary embodiment described above, the CPU loads software (a program) and executes information processing, but the information processing may be executed by various processors other than the CPU. Examples of such a processor include a programmable logic device (PLD), such as a field-programmable gate array (FPGA), whose circuit configuration is modifiable after fabrication, and a dedicated electric circuit, such as an application specific integrated circuit (ASIC), which is a processor having a circuit configuration exclusively designed to execute a specific process. Further, the information processing may be performed by one of the various processors described above or by a combination of two or more similar or dissimilar processors (for example, a combination of a plurality of FPGAs or a combination of a CPU and an FPGA). More specifically, the hardware structure of these various processors is an electric circuit formed by a combination of circuit elements such as semiconductor devices.

Further, in the above exemplary embodiment, a case where the information processing program is stored (installed) in the ROM or in the repository in advance has been described by way of non-limiting example. The program may be recorded on a non-transitory recording medium and provided. Examples of the non-transitory recording medium include a compact disc read-only memory (CD-ROM), a digital versatile disc read-only memory (DVD-ROM), and a universal serial bus (USB) memory. Alternatively, the program may be downloaded from an external apparatus via a network.

In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
receive input of information for identifying a target object for manufacturing,
identify a component of the target object, and
create management information to manage classification of the component of the target object as a first kind of component or a second kind of component, the first kind of component being a component produced by a three-dimensional printer, the second kind of component being a component procured without using the three-dimensional printer.

2. The information processing apparatus according to claim 1,
wherein the processor is configured to determine whether the component is of the first kind or of the second kind based on structured information that is structured with respect to the component.

3. The information processing apparatus according to claim 2,
wherein the processor is configured to update the structured information in response to the management information being created.

4. The information processing apparatus according to claim 1,
wherein the processor is configured to identify the component based on design information including plans and materials.

5. The information processing apparatus according to claim 1,
wherein the processor is configured to identify the target object based on design information including plans and materials.

6. The information processing apparatus according to claim 1,
wherein the processor is configured to identify the target object and the component based on design information including plans and materials.

7. The information processing apparatus according to claim 4,
wherein the design information is computer-aided design (CAD) data.

8. The information processing apparatus according to claim 5,
wherein the design information is computer-aided design (CAD) data.

9. The information processing apparatus according to claim 6,
wherein the design information is computer-aided design (CAD) data.

10. The information processing apparatus according to claim 1,
wherein the processor is configured to determine whether the component is of the first kind or of the second kind based on a time at which the component is identified.

11. The information processing apparatus according to claim 10,
wherein the processor is configured to determine whether the component is of the first kind or of the second kind based on information regarding environment related to the time at which the component is identified.

12. The information processing apparatus according to claim 1,
wherein the processor is configured to determine whether the component is of the first kind or of the second kind by referring to management information regarding a component that is the same as the component of the target object and that belongs to a different target object.

13. The information processing apparatus according to claim 1,
wherein the processor is configured to determine whether the component is of the first kind or of the second kind in consideration of a cost of production by the three-dimensional printer.

14. The information processing apparatus according to claim 1,
wherein the processor is configured to determine whether the component is of the first kind or of the second kind in consideration of quality of the target object.

15. The information processing apparatus according to claim 1,
wherein the processor is configured to create purchase order information regarding the component in response to a determination that the component is of the second kind.

16. The information processing apparatus according to claim 1,
wherein the processor is configured to create the management information in the Extensible Markup Language (XML) format.

17. A non-transitory computer readable medium storing a program causing a computer to execute a process for information processing, the process comprising:
receiving input of information for identifying a target object for manufacturing;
identifying a component of the target object; and
creating management information to manage classification of the component of the target object as a first kind of component or a second kind of component, the first kind of component being a component produced by a three-dimensional printer, the second kind of component being a component procured without using the three-dimensional printer.

18. An information processing apparatus comprising:
means for receiving input of information for identifying a target object for manufacturing;
means for identifying a component of the target object; and
means for creating management information to manage classification of the component of the target object as a first kind of component or a second kind of component, the first kind of component being a component produced by a three-dimensional printer, the second kind of component being a component procured without using the three-dimensional printer.
